(19) United States
(12) Patent Application Publication
(10) Pub. No.: US 2002/0156914 A1
(43) Pub. Date: Oct. 24, 2002

(54) Controller for managing bandwidth in a communications network

(76) Inventors: Waichi C. Lo, Kanata (CA); Michel M. Dallaire, Aylmer (CA); Christopher L. Hobbs, Ottawa (CA)

Correspondence Address: Angela C. de Wilton, NORTEL NETWORKS LIMITED, Intellectual Property Law Group, P.O. Box 3511, Station "C", Ottawa, ON, K1Y 4H7, CA

(21) Appl. No.: 09/778,824

(22) Filed: Feb. 8, 2001

Related U.S. Application Data
(60) Provisional application No. 60/208,946, filed on May 31, 2000.

(51) Int. Cl. G06F 15/16; G06F 15/173

(52) U.S. Cl. 709/238; 709/203

(57) ABSTRACT

A controller for managing bandwidth in a communications network is disclosed. The controller includes a service controller, a service interface to a service network element, and a facility interface to a transport network element. The controller works at three levels to optimize network resources. At the packet layer, the controller automatically sets up end-to-end MPLS paths, and dynamically balances the utilization of the paths by adjusting the bandwidth allocation and traffic and distribution on the paths. Between the optical and packet layers, the controller works to allow optical resources to be used directly by the packet layer to respond to congestion or increased demand at the packet layer.

### CROSS REFERENCE TO RELATED APPLICATIONS

This application claims the benefit of U.S. Provisional Application 60/208,946, filed May 31, 2000.

### FIELD OF THE INVENTION

The invention is related to communication networks, and in particular to managing bandwidth in a communications network.

### BACKGROUND OF THE INVENTION

The explosive growth of data networks, particularly the Internet, presents both tremendous opportunities and challenges for service providers. Service providers are struggling to keep up with the demand for bandwidth created by new users, new technologies and new high-bandwidth applications. To meet this ever-expanding demand, service providers are re-evaluating how to configure their networks. Traditional networks, developed using an overlay model where layers are built and managed independently, make it difficult for service providers to allocate network resources in a manner that allows them to cost effectively provide services.

In addition to the growth in the demand for bandwidth, the dynamically changing nature of traffic carried on networks creates a need for the capability to flexibly, scalably, and cost-effectively allocate network resources to provide required bandwidth. Currently, to address these dynamically changing bandwidth requirements, service providers have little choice but to engineer their networks for “worst-case” traffic volumes, which allows them to meet service commitments but results in under-utilized network resources. Furthermore, when traffic patterns change to an extent that requires reconfiguration of their networks, service providers must manually engineer and provision new connections at both the packet and optical layers of the network. This is a complex and time-consuming task in a multi-layer network.

Still further, the multi-layer nature of traditional networks makes it difficult for service providers to identify opportunities for improving the management of network resources. For example, an IP network (layer-3) may run over a frame relay network, which runs over an ATM network (layer-2), which runs over a SONET/SDH network (layer-1), which in turn runs over an optical/wavelength network. The multi-layer nature of the network allows each layer to evolve independently, while continuing to support legacy services. However, the large number of different devices in the network complicates the task of managing network resources to cost effectively meet service commitments. Moreover, each layer of the network typically has an independent management structure and associated processes that only have visibility of the topology and state information of that particular layer. This independent structure adds complexity to the network-wide operation tasks such as provisioning, performance monitoring and fault isolation, thereby increasing the cost of operating the network.

Therefore, a means of managing bandwidth in a multi-layer network to provide services in a manner that makes cost effective use of network resources under changing bandwidth requirements is desired.

### SUMMARY OF THE INVENTION

An object of the present invention is to provide an improved controller for managing bandwidth in a communications network.

At the packet layer, the controller defines paths through the network between endpoints from which network bandwidth is provided according to current traffic requirements. Embodiments of the controller allocate bandwidth on each path according to current usage on that path in relation to high and low thresholds, and distribute traffic between paths having the same source and destination endpoints such that these paths have equal percent utilization. At the physical layer, embodiments of the controller are operable to add, delete, or reconfigure physical connections as required for this allocation and distribution of bandwidth at the packet layer.

In accordance with an aspect of the present invention there is provided a controller for managing bandwidth in a communications network. The controller comprises a service controller, a service interface between the service controller and a service network element in the network for managing paths, and a facility interface between the service controller and a transport network element in the network for managing connections. The service controller is operable to automatically set up paths and dynamically balance the bandwidth utilization among a plurality of selected paths in response to current traffic requirements on the plurality of selected paths.

In accordance with another aspect of the present invention there is provided a controller for a communications network comprising resource conservation means for automatically maintaining the bandwidth allocation of paths between two service nodes in the network at a level that is adjusted dynamically in accordance with a current traffic utilization level of the paths, and resource deployment means for redistributing network resources between the paths.

An advantage of the present invention is that it automates traffic-engineering functions, thereby reducing network operation costs. Further, embodiments of the invention provide the ability to automatically include service commitment information so that these commitments are addressed as network resources are dynamically allocated. By providing the means to dynamically allocate network resources, embodiments of the invention allow service providers to automatically manage network bandwidth in accordance with dynamic changes in bandwidth requirements.

Other aspects of the invention include combinations and sub combinations of the features described above other than the combinations described above.

### BRIEF DESCRIPTION OF THE DRAWINGS

The foregoing and other objects, features and advantages of the invention will be apparent from the following detailed description of embodiments of the invention with reference to the accompanying drawings, in which:

In FIG. 1 is a schematic representation of a layered network provided with a controller that is according to an embodiment of the invention;

FIG. 2 is a functional block diagram of the network of FIG. 1 provided with a plurality of the controllers of FIG. 1;

FIG. 3 is a functional block diagram of the controller of FIG. 1;

FIG. 4 is a graph of bandwidth demand vs. time of day for a typical network;

FIG. 5 is a graph of bandwidth demand vs. time of day illustrating the effect of bandwidth management provided by the controller of FIG. 1;

FIG. 6 is a diagram of a network having four paths for which controllers of FIG. 1 are used to provide bandwidth management;

FIG. 7 is a graph comparing the traffic throughput of a network with and without controllers of FIG. 1 providing bandwidth management;

FIG. 8 is a topographical representation of a network provided with controllers of FIG. 1, the network logically partitioned into domains, areas, and nodes; and

FIG. 9 is a hierarchical representation of the network of FIG. 8.

### DETAILED DESCRIPTION

Smart packet/optical interworking means the ability for the optical and packet layers of the network to share information and for action to be taken based on this information in order to manage the network dynamically. The controller described herein provides this functionality automatically. The controller is a smart packet/optical inter-working controller that uses information from the packet and optical layers about the network topology and network wide policy information for reacting to changing bandwidth demands by making dynamic network configuration adjustments.

In this specification, the term “domain” is used to denote a carrier's administrative zone. For traffic engineering reasons, a carrier divides its domain into a number of ‘areas’. Each area consists of a collection of nodes. A ‘node’ refers to a network node, which comprises a packet (service) switch, a transport (facility) switch, and optionally a controller that is in accordance with an embodiment of the invention. Each network node does not require one of these controllers, moreover, one or more of controllers could reside in other types of network elements, possibly even a network element dedicated to the controller.

FIG. 1 is a schematic representation of a layered network provided with a controller 10 that is in accordance with an embodiment of the invention. The network 1 has a service layer (layer m) and a facility layer (layer n), both represented as separate clouds. The controller 10 interfaces with the layers to create and manage packet-oriented service paths in the service layer and connection-oriented facility connections in the facility layer. The controller 10 automatically sets up the packet-oriented service paths and dynamically balances the bandwidth utilization among a plurality of these service paths in response to current traffic requirements on the paths. The controller 10 is also capable of automatically setting up the facility connections in response to current traffic requirements of the service paths.

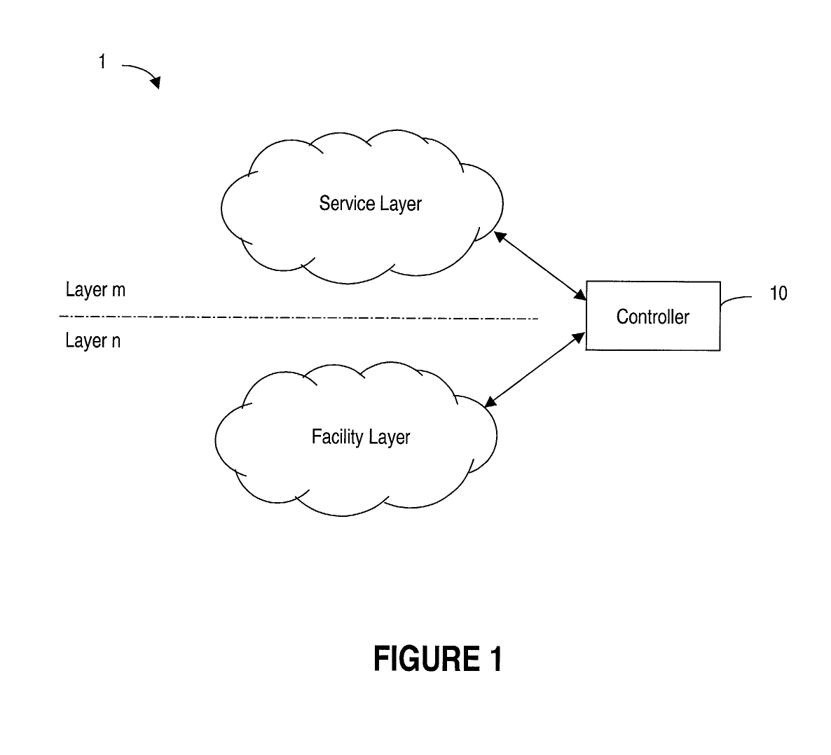

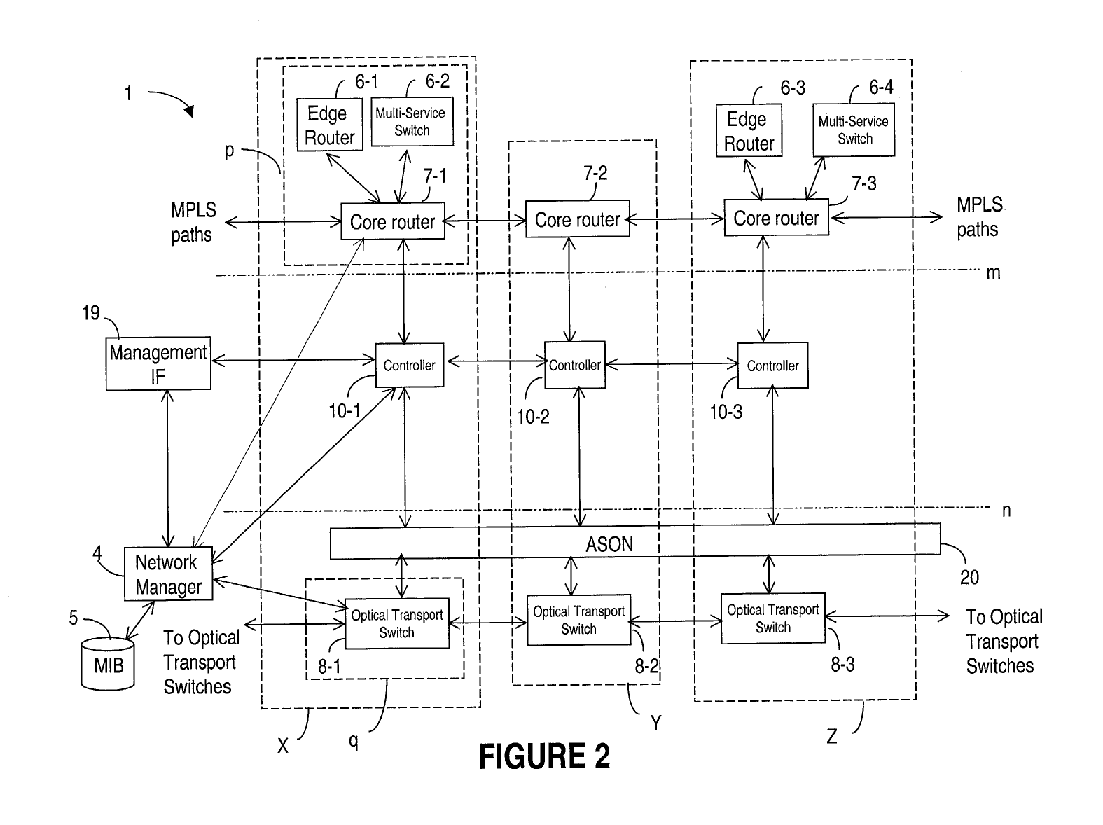

FIG. 2 is a functional block diagram of a network 1 provided with controllers 10-1, 10-2, and 10-3, referred to generally as controllers 10, which are in accordance with an embodiment of the invention. The network 1 includes three nodes X, Y, and Z. The controllers 10 are useful in much larger networks, having numerous nodes, as will be described later. Each of the network nodes includes a core router 7, an optical transport switch 8, and a controller 10. For example, the first node X includes the transport switch 8-1, the controller 10-1, and the core router 7-1. Similarly, the second and third nodes, Y and Z, include the transport switches 8-2 and 8-3, the controllers 10-2 and 10-3, and the core routers 7-2 and 7-3. The core routers 7 could be any type of service switch and the transport switches 8 could be any type of facility switch.

The controllers 10 each affect the service layer and the facility layer to manage network bandwidth by controlling network resources. With respect to FIG. 2, the service layer is a packet layer and the facility layer is an optical transport layer. At the packet layer, depicted in FIG. 2 by components above the dashed line labelled ‘m’, the controllers 10 automatically set up end-to-end multi-protocol label-switched (MPLS) paths, or other types of path-oriented services. The controllers 10 automatically balance the utilization of bandwidth allocated to the paths by dynamically adjusting the bandwidth allocation and distribution of traffic over the paths, as required. Also, between the optical transport and packet layers, the controllers 10 provide the capability of configuring the interconnection of optical resources in order to respond to congestion or increased demand in the packet layer. The optical transport layer is depicted in FIG. 2 by components below the dashed line labelled ‘n’.

A network manager 4, in conjunction with a management information base (MIB) 5, provides integrated management of the network nodes X, Y, Z, and their controllers 10 via a management interface 19.

A service node is defined as a node that provides a path-oriented service according to a service level agreement. As shown in FIG. 2, at the packet layer m (layer-3), a service node, represented by the dashed line labeled ‘p’, comprises a packet core router 7-1, and one or more edge routers 6-1 or multi-service switches 6-2. Each edge router 6-1, 6-3 acts as a peripheral to provide Internet protocol (IP) interfaces to its respective core router. Each multi-service switch 6-2, 6-4 acts as a peripheral on its respective core router to provide asynchronous transfer mode (ATM), IP, Frame Relay, or other packet-oriented service interfaces.

The controllers 10 each interact with layer-3 equipment to gain a global view of the network 1 through automatic discovery of network topology, and by accessing data on network traffic levels and status. The controllers 10 adapt the allocation of resources to network traffic by creating, aggregating, and changing the characteristics of the MPLS paths.

A facility node is defined as a lower level resource required by the service node. Each of the controllers 10 provides the capability for the packet layer to use the resources of the optical layer in response to congestion, or increases in demand for bandwidth at the packet layer. At the optical layer (layer-1), a facility node, represented by the dashed line labelled ‘q’ in FIG. 2, comprises an optical transport switch 8-1. The optical transport switches 8 are programmable and capable of switching on at least one of the following levels: fiber, wavelength, wavelength band (or group of wavelengths), and SONET/SDH frames. The network is also provided with a facility connection-signalling interface, which in this case is an Automatically Switched Optical Network (ASON) functionality interface 20. The term ASON is used for the protocols within the transport domain that determine topology and establish connections.

As indicated above, functions of the controllers 10 can be divided into two categories, namely intra-layer functions and inter-layer functions. Regarding inter-layer functionality, the controllers 10 provide a network with intelligent dynamic resource management between a service node (i.e. a node of the layer-3 network) and a facility node (i.e. a node of the layer-1 network). Regarding the intra-layer functionality of the controllers 10, at the service node layer, each of the controllers 10 has information pertaining to the service level agreements (SLAs), by way of the policy information, and manages resources at this layer to meet the SLAs.

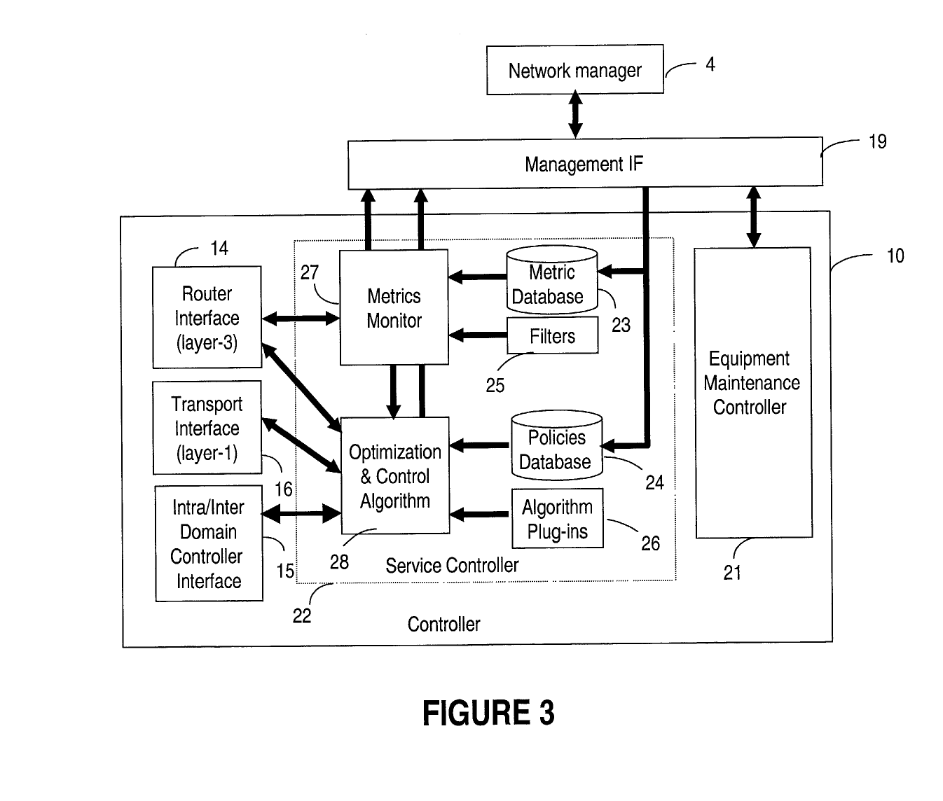

Referring to FIG. 3, which is a functional block diagram of the controller 10, the controller 10 has a transport interface 16 to the ASON 20. The transport interface 16 provides a proxy-signalling interface to the ASON 20 for the establishment of layer-1 source-routed connections. These layer-1 connections are set up and managed using the following parameters. An explicit route hop parameter specifies the route of an optical connection. For example, given a maximum of 64 nodes per domain, a particular controller 10 could use up to 64 explicit route hop parameters for one connection. A traffic parameter defines the required resources and traffic capabilities of the connection. The traffic parameters required for an optical connection are connection bandwidth and maximum delay. A pre-emption parameter specifies the pre-emption level of a connection. This parameter is used to identify connections that carry pre-emptable traffic, which may be pre-empted if the connection is required for restoration purposes.

The controller 10 has a router interface 14 to its respective router 7. The router interface 14 is used by the controller 10 to control the layer-3 MPLS paths, such as label-switched paths (LSP). The controller uses the router interface 14, which can be a simple network management protocol (SNMP) interface, to send requests to the layer-3 service node to create or delete LSPs, and to change traffic parameters and/or routes of the LSPs. The router interface 14 may also support resource reservation protocol (RSVP), a protocol that allows channel or paths in a network to be reserved for transmission of high-priority messages.

The layer-3 logical paths are set up and managed using the following parameters. An explicit route parameter specifies the path of the LSP. The content of this parameter is a set of explicit route hop links. For example, given a maximum of 64 nodes per domain, up to 64 explicit route hop links could be used to set up one LSP. Each of the controllers 10 uses strict explicit route (ER) specification of paths, typically in the form of Internet protocol version 4 (IPv4) addresses and LSP identifiers (ID). A traffic parameter defines the resources and traffic capabilities of the LSP. The peak burst size, committed data rate, committed burst size, and excess burst size define the bandwidth requirements of the LSP. Additionally, a weight parameter may be used to give the LSP a weighted value for a route selection hashing algorithm where multiple LSPs are available for a given quality of service (QoS) and destination. The LSPID allows the controllers 10 to modify the bandwidth of existing LSPs or their weighted value.

The router interface 14 between the service nodes and the controllers 10 is also a polled interface that makes information about the state of the LSPs, state of ports, and state of links available to the controllers 10. The router interface 14 is used to access OSPF data to obtain topology information of the layer-3 network.

The controllers 10 use the transport interface 16 to gain access to the optical layer to map packet layer service requirements to available optical layer resources. This is done by automatically setting up the end-to-end physical path topology for the layer-3 network using configuration data such as traffic parameters provided by the network manager 4. The controllers 10 also dynamically set-up, tear-down and alter connections at the layer-1 level. As indicated above, each of the controllers 10 provides interaction between the optical and packet layers, by allocating optical resources to the packet layer in order to respond to congestion or increased demand at the packet layer.

The network manager 4 provides a unified view of the network and offers a human interface to an operator to display the network information. A management interface 19 is provided to interface the controllers 10 to the network manager 4 allowing network operators to control the controllers 10 by means of user-defined policies. These policies can be adjusted, thereby allowing the network operator to customize the actions of each of the controllers 10. The network operators can also obtain records of audit trails and explanations of every action performed, as well as recommended actions from a given controller 10 in response to the controller determining that human intervention is required. The management interface 19 includes a simple command line interface, which can also be used as a computer-to-computer interface.

The router interface 14 to the core routers 7 and transport interface 16 to the optical transport switches 8, via the ASON 20, are designed to be open interfaces such that each of the controllers 10 can be used in an open environment. An inter/intra-domain interface 15 is included for an internal peer-to-peer interface and an internal hierarchical interface between the controllers 10, as will be explained in more detail later.

Each of the controllers 10 is capable of performing at least the following functions:

1. Automatically initiating the establishment of physical connectivity (layer-1), via the ASON interface, for the layer-3 network based on user-defined policies (such as QoS).

2. Automatically initiating the establishment of MPLS connectivity through the layer-3 network based on the user defined policies and user-defined traffic requirements.

3. Automatically seeking to optimize packet traffic services based on the user-defined policies by managing layer-3 and layer-1 resources.

4. Collecting and reporting network utilization information.

5. Reporting recommended actions to network operators.

6. Executing MPLS path protection restoration based on QoS agreements.

Referring again to FIG. 3, the controller 10 also includes an equipment maintenance controller 21, and a service controller 22. The maintenance controller 21 provides regular maintenance capability such as software upgrades and alarm reporting. The service controller 22 is comprised of several functional sub-blocks: a metrics database 23, a policy database 24, data filters 25, algorithm control plug-ins 26, metrics monitor 27, and an optimization and control algorithm 28.

As previously described, the management interface 19 provides an operator with access to the controller 10, via the network manager 4, for provisioning resources and other management functions. The management interface 19 allows the operator to manipulate policies, define the limits of the controller's 10 actions (e.g. report recommendations only, act on recommendations automatically, etc.), set the controller's IP addresses through the local command line interface, specify the network addresses of the nodes comprising the controller's 10 domain, and access network statistics kept by the controller 10. For example, these statistics may include details of recommendations made with reasons, current state of internal variables, and details of services that could not be carried because of lack of equipment. The management interface 19 also allows access to the controller's 10 performance statistics, such as the number of messages exchanged between controllers 10, the computation time for the various algorithms, and the numbers of software faults. In addition, the management interface 19 receives alarms from the controller 10 when components fail and receives information about attempted breaches of security.

The metrics database 23 and the policy database 24 are controlled via the network manager 4. The metrics database 23 stores parameters used to evaluate traffic conditions to determine if action should be taken by the controller 10. Examples of these parameters are threshold values and data sampling intervals. The policy database 24 stores rules for the optimization and control algorithm 28. These rules are used by the controller 10 to determine if the action to be performed is appropriate. The plug-ins 26 are used to enable more flexible control. They also allow the optimization and control algorithm 28 to be upgraded without upgrading other software. Control algorithm plug-ins 26 allow different types of controls to be applied to different scenarios. The filters 25 are algorithms that provide additional data processing, for example, to eliminate transient conditions from collected data before it is used by the controller 10.

The metrics monitor 27 is a data collection and processing engine. The metrics monitor 27 interacts with the packet equipment (i.e. the core routers 7 in FIG. 2) to collect performance data, filter the data if required, and use parameters from the metrics database 24 for comparison with the collected data. The results of this comparison are fed into the optimization and control algorithm 28. The metrics monitoring function 27 also reports some of the performance metrics to the network operator.

The optimization and control algorithm 28 performs all the optimization actions and resource management functions. All actions are governed by the policy database 24. The algorithm being used to interpret the database is provided by the algorithm plug-in 26. Different algorithm plug-ins provide different functions such as building the initial connectivity between the core routers 7. When an action is to be taken, the optimization and control algorithm 28 uses the router interface 14 or transport interface 16 to send commands to the appropriate layer.

The router interface 14 and the transport interface 16 provide an interface to the packet equipment and the transport equipment, respectively. These interfaces encode, send, and receive messages according to the protocols being used. They provide decoupling between the functionality of the controller 10 and other equipment (e.g. the core routers 7 and the transport switches 8 in FIG. 2) such that the controller 10 can adapt to interface changes, or interface with different equipment that does not support standard interfaces.

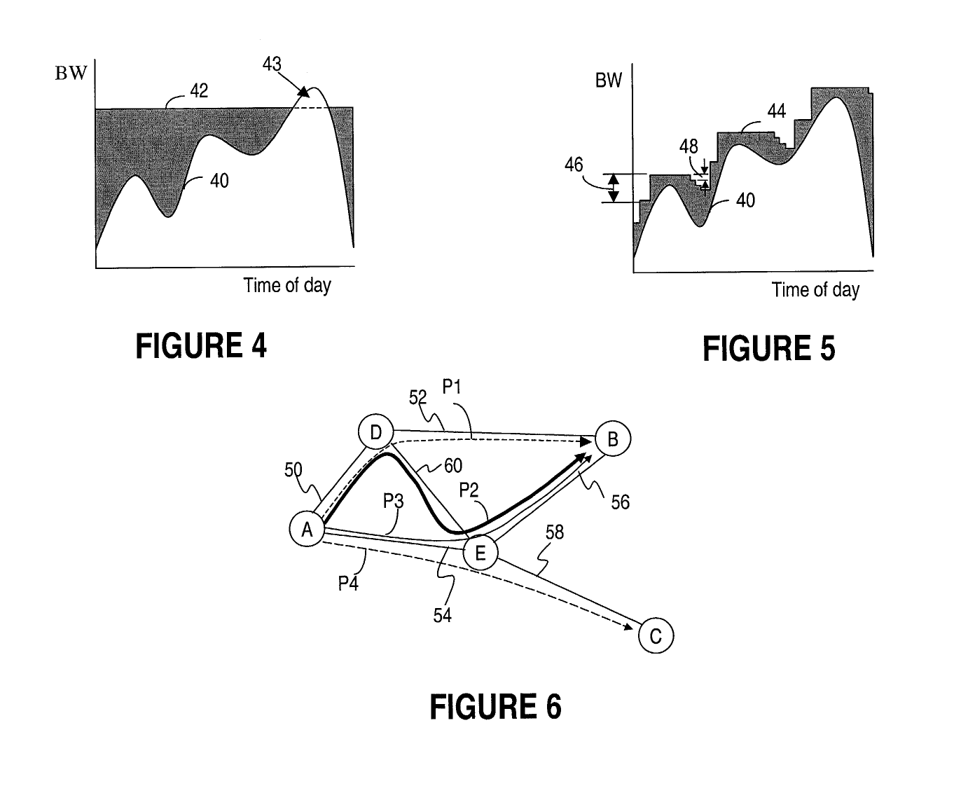

FIG. 4 is a graph of bandwidth demand vs. time of day for a typical network without the controllers 10. In order to maintain a desired grade of service, the bandwidth between two network nodes is engineered to a level that will satisfy traffic requirements most of the time, if not all the time. In other words, a link between two network nodes is always over-engineered and therefore most of the time it is under-utilized. This under-utilization is illustrated in FIG. 4. The shaded portion under the engineered level 42 and above the usage curve 40 represents the network resources not being used. Typically, the total amount of over-engineered bandwidth is very significant in a network. If this bandwidth can be reduced, then a more cost-effective use of the network resources will be realized without sacrificing the grade of service being provided. FIG. 4 also shows a condition of network congestion, depicted by the area 43 that is under the usage curved 40 and above the engineered level 42. During a condition of network congestion it is unlikely that a service provider is meeting all of its service commitments.

FIG. 5 is a graph of bandwidth demand vs. time of day illustrating the effect of bandwidth management, as provided by the controller 10. The shaded portion under the currently allocated level 44 and above the usage curve 40 represents the network resources not being used. The amount of resources not being used is significantly lower in FIG. 5 compared to FIG. 4. Additionally, the state of network congestion shown in FIG. 4 is avoided by using the controller 10. The controller 10 reduces the amount of over-engineered bandwidth (i.e. unused resources) by using logical connections (MPLS paths) for the transmission of traffic, and dynamically adjusting the amount of bandwidth allocated to each MPLS path according its current utilization. This method results in the following advantages over current networks:

1. Since the bandwidth allocated between two points in the network is dynamically adjusted according to current traffic level, rather than a predetermined amount assigned during commissioning, bandwidth is conserved for other connections.

2. If congestion does occur, since packets dropped due to the congestion are dropped at the entry point of an MPLS path, they do not affect the intermediate nodes in the path, as is the case with the open shortest path first (OSPF) protocol. This behavior allows the controller 10 to monitor network performance by measuring the packet loss at the ingress point of a router, which is easy to monitor.

When the controller 10 detects the traffic level rising beyond a configurable threshold, the controller 10 will increase 46 the bandwidth allocated to that path. When the traffic level drops below a configurable threshold, the controller 10 decreases 48 the bandwidth allocated to the path, but by a value smaller than the previous increment. In this way, the allocated bandwidth closely tracks traffic requirements as they change, thereby using resources more cost effectively since less allocated resources go unused.

By dynamically allocating bandwidth for an MPLS path the controller 10 makes better utilization of network resources since resources can be redistributed to other MPLS paths where they are needed, and taken away from MPLS paths where they are not needed. The controller 10 automatically adjusts the bandwidth allocation of an MPLS path in three steps:

1. When a path's utilization exceeds the pre-configured threshold, the controller 10 will first attempt to increase the bandwidth allocated to that path. The increase in bandwidth allocation is an amount such that the average utilizations of paths having the same source and destination nodes as that path are equal.

2. If there is not enough bandwidth available on the existing physical route left to increase the bandwidth allocation of that path, then the controller 10 will attempt to create a new MPLS path for that path using a different physical route.

3. If the above two steps are not successful, the controller 10 will use the ASON services to create a new optical route, thereby changing the router-to-router topology (layer-1) to meet the packet layer (layer-3) requirements for bandwidth.

The controller 10 accesses the following inputs about the state of the network by polling the MPLS management information database 5 (MIB) located at the layer-3 service node. The ‘MPLS bandwidth (BW)’ is defined as the total allocated bandwidth of a given path, ‘MPLS path occupancy (PO)’ is defined as the percentage of the allocated bandwidth of a given path that is being occupied by traffic on that path (i.e. percent utilization of the path), and ‘the router port link bandwidth’ is defined as the total unallocated bandwidth on a link between two nodes in the network. The term ‘High occupancy threshold (HOT)’ in this specification is the maximum percentage of allocated bandwidth in use on a given MPLS path before the controller 10 needs to take action to redistribute traffic. The term ‘Low occupancy threshold (LOT)’ is the minimum percentage of allocated bandwidth in use on a given MPLS path before the controller 10 needs to take action to redistribute traffic.

The controller 10 processes the above inputs and data at fixed intervals. In response to path occupancy levels that exceed the threshold value, the controller 10 performs two actions. First, the controller 10 adjusts the bandwidth allocation of an MPLS path that has exceeded an occupancy threshold. If the path occupancy is too high, the controller 10 will increase the bandwidth allocation on that path, provided that bandwidth is available on the links used for that path. If the path occupancy is too low, the controller 10 will decrease the bandwidth allocation on that path. In this way the controller 10 provides a means of resource conservation for maintaining the bandwidth allocation of MPLS paths between two traffic nodes in the network. Second, the controller 10 redistributes the traffic among all MPLS paths to ensure that the traffic is balanced relative to the amount of bandwidth on each path. In this way the controller 10 provides a resource deployment means for redistributing network resources between the MPLS paths.

To adjust the bandwidth allocation on an MPLS path that has exceeded an occupancy threshold, the controller 10 performs the following calculations:

Path Bandwidth Allocation

High Occupancy Threshold (HOT) Exceeded:

To determine the increase I (in percentage) in bandwidth allocation that a path requires, the controller 10 calculates:

I=minimum(LBWA,((PO−LOT)×BIR)) EQ1

where LBWA is the Link Bandwidth available, PO is path occupancy, LOT is the low occupancy threshold, and BIR is the bandwidth increased rate, which is normally set to 1. The BIR is used to control the rate of increases in bandwidth allocation. For example, where the occupancy on the path is 90%, the high occupancy threshold is 80% and the low occupancy threshold is 50%, the increase in bandwidth required for this path is 90%−50%=40% (i.e. with BIR=1). The controller 10 communicates this requirement for a 40% increase in bandwidth to the packet layer.

Low Occupancy Threshold (LOT) Reached:

To determine the decrease D in bandwidth that a path requires, the controller 10 calculates:

D=(HOT−PO)×BDR, EQ2

where HOT is the high occupancy threshold, and BDR is the bandwidth decrease rate, which is normally set to 0.25. The BDR is used to control the rate of decreases in bandwidth allocation, and normally BDR<BIR.

For example, where the occupancy on the path is 30%, the high occupancy threshold is 80% and the low occupancy threshold is 40%, the decrease in bandwidth required for this path is (80−30)×0.25=12.5%.

The controller 10 communicates this requirement for a 12.5% decrease in bandwidth to the packet layer, using the router interface 14 to send a label request message containing a traffic parameter, and a LSPID parameter. The combination of these two parameters enables the controller 10 to decrease the bandwidth allocation of the designated path. These increases and decreases in bandwidth allocation are restricted to remain within an operating range, which is determined by the user-defined policies (or SLAs).

Path Bandwidth Redistribution

Bandwidth Share Calculation

After the controller 10 has adjusted the allocated bandwidth on an MPLS path(s), it redistributes the traffic among the MPLS path(s) with the same source and destination as that path to equalize the path occupancy (i.e. percent utilization) of those paths. To illustrate how the controller 10 redistributes the traffic an example is provided which makes reference to FIG. 6 and Table 1.

FIG. 6 is a diagram of a network having four paths for which the controllers 10 are used to provide bandwidth management. The network is composed of five network nodes A to E interconnected by six links 50-60. The node D it is a bi-directionally connected via links 50 and 52 to the nodes A and B, respectively. The node E is a bi-directionally connected via a links 54, 56, 58, and 60 to the nodes A, B, C, and D, respectively. Three paths P1, P2 and P3 start at node A and finish at node B, while a fourth path P4 starts at node A and finishes at node C. The route for the first path P1 is ADB using the links 50 and 52. The route for the second path P2 is ADEB using the links 50, 60, and 56. The route for the third path P3 is AEB using the links 54 and 56. Finally, the route for the fourth path P4 is AEC using the links 54 and 58.

Table 1 shows how the controllers 10 balance traffic among the MPLS paths P1-P3 shown in FIG. 6. The paths in this network have a high occupancy threshold of 80% and a low occupancy threshold of 50%. The links are limited to 100 Mbit/s. Network changes are indicated in bold in Table 1. The controller 10 initiated changes are indicated with underlining.

TABLE 1
MPLS resource management

| | | | | | | | | Share | | |
|---|---|---|---|---|---|---|---|---|---|---|
| | | | Traffic | Traffic | | | | Of | Actual | |
| | | | NodeA | NodeA | | | BW | BW | Traffic | Path |
| | | | to | to | | | allocated | alloc./ | on | Occu- |
| | | | NodeB | NodeC | | | to path | path | Path | pancy |
| | | | (Mb/s) | (Mb/s) | | | (Mb/s) | (%) | (Mb/s) | (%) |
| Time | Source | Dest | T_{A-B} | T_{A-C} | Path | Links | BW_{Pn} | R_{Pn} | T_{Pn} | PO |
| 00:00 | A | B | 50 | | P1 | A-D | 20 | 22 | 11 | 56 |
| | | | | | | D-B | | | | |
| | A | B | | | P2 | A-D | 40 | 44 | 22.2 | 56 |
| | | | | | | D-E | | | | |
| | | | | | | E-B | | | | |
| | A | B | | | P3 | A-E | 30 | 33 | 16.7 | 56 |
| | | | | | | E-B | | | | |
| | A | C | | 45 | P4 | A-E | 70 | 100 | 45 | 64 |
| | | | | | | E-C | | | | |
| 01:00 | A | B | 85 | | P1 | A-D | 20 | 22 | 18.9 | 94 |
| | | | | | | D-B | | | | |
| | A | B | | | P2 | A-D | 40 | 44 | 37.8 | 94 |
| | | | | | | D-E | | | | |
| | | | | | | E-B | | | | |
| | A | B | | | P3 | A-E | 30 | 33 | 28.3 | 94 |
| | | | | | | E-B | | | | |
| | A | C | | | P4 | A-E | 70 | 100 | 45 | 64 |
| | | | | | | E-C | | | | |
| 01:10 | A | B | 85 | | P1 | A-D | 28.8 | 25 | 21 | 73 |
| | | | | | | D-B | | | | |
| | A | B | | | P2 | A-D | 57.6 | 49 | 42.1 | 73 |
| | | | | | | D-E | | | | |
| | | | | | | E-B | | | | |
| | A | B | | | P3 | A-E | 30 | 26 | 21.9 | 73 |
| | | | | | | E-B | | | | |
| | A | C | | 45 | P4 | A-E | 70 | 100 | 45 | 64 |
| | | | | | | E-C | | | | |
| 02:00 | A | B | 40 | | P1 | A-D | 28.8 | 25 | 9.9 | 34 |
| | | | | | | D-B | | | | |
| | A | B | | | P2 | A-D | 57.6 | 49 | 19.8 | 34 |
| | | | | | | D-E | | | | |
| | | | | | | E-B | | | | |
| | A | B | | | P3 | A-E | 30 | 26 | 10.3 | 34 |
| | | | | | | E-B | | | | |
| | A | C | | 52 | P4 | A-E | 70 | 100 | 52 | 74 |
| | | | | | | E-C | | | | |
| 02:10 | A | B | 40 | | P1 | A-D | 25.3 | 25 | 9.9 | 39 |
| | | | | | | D-B | | | | |
| | A | B | | | P2 | A-D | 50.5 | 49 | 19.8 | 39 |
| | | | | | | D-E | | | | |
| | | | | | | E-B | | | | |
| | A | B | | | P3 | A-E | 26.3 | 26 | 10.3 | 39 |
| | | | | | | E-B | | | | |
| | A | C | | 52 | P4 | A-E | 70 | 100 | 52 | 74 |
| | | | | | | E-C | | | | |
| 03:00 | A | B | 40 | | P1 | A-D | 20 | 22 | 11.1 | 56 |
| | | | | | | D-B | | | | |
| | A | B | | | P2 | A-D | 40 | 44 | 22.2 | 56 |
| | | | | | | D-E | | | | |
| | | | | | | E-B | | | | |
| | A | B | | | P3 | A-E | 30 | 33 | 16.7 | 56 |
| | | | | | | E-B | | | | |
| | A | C | | 52 | P4 | A-E | 70 | 100 | 52 | 74 |
| | | | | | | E-C | | | | |

For rebalancing the traffic on existing MPLS paths, the traffic on each path n connecting the same source and destination nodes is calculated by the controller 10 as follows:

R_{Pn}=BW_{Pn}/BW_{S-D} EQ₃

and the traffic on path Pn should be:

T_{Pn}=T_{S-D}−R_{Pn} EQ4

where BW_{Pn} is the bandwidth allocated to path n, BW_{S-D} is the sum of the allocated bandwidth on all paths from source node S to destination node D, R_{Pn} is the ratio of bandwidth allocation (BW_{Pn} to BW_{S-D}) expressed in percent, T_{S-D} is the total traffic from the source node S to destination node D, and T_{Pn} is the traffic on path n.

Path occupancy PO (i.e. percent utilized bandwidth allocated to the path) is determined from the allocated bandwidth of the path and the traffic on the path:

PO=(T_{Pn}/BW_{Pn})×100% EQ5

For the example of FIG. 5 and Table 1, the first path P1 has an allocated bandwidth of BW_{P1}=20 Mbit/s (first line of Table 1), and the sum ΣT_{A-B} of all paths between the nodes A and B is 20+40+30=90 Mbit/s. The equation EQ3 for the ratio of traffic on a path gives this ratio for the first path P1 as R_{P1}=20/90=22%. Since the traffic between the nodes A and B is 50 Mbit/s, the actual traffic on the first path P1 is given by the fourth equation EQ4 as:

50 Mbit/s×22%=11 Mbit/s.

When the traffic from the source and destination nodes T_{S-D} changes, as shown in the fifth line of Table 1, the path occupancy for all three paths P1-P3 between of the nodes A and B change accordingly, from 56% to 94%. That is:

T_{P1}=T_{A-B}×R_{P1}=85 Mbit/s×22%=18.9 Mbit/s

PO=(18.9 Mbit/s/20 Mbit/s)×100%=94%

The bandwidth allocation of each path is changed according to EQ1 and EQ2 and the traffic is redistributed among paths having the same source and destination according to EQ3 and EQ4 as previously described. The path occupancy is then calculated for each path according to EQ5. In row number 11 the bandwidth allocation of the path P3 is limited by its LBWA of 30 Mb/s. The bandwidth allocation of the paths P1 to P3 in row numbers 21 to 23 are the result of several iterations of bandwidth allocation adjustments made over the immediately preceding rows but not shown for the sake of brevity.

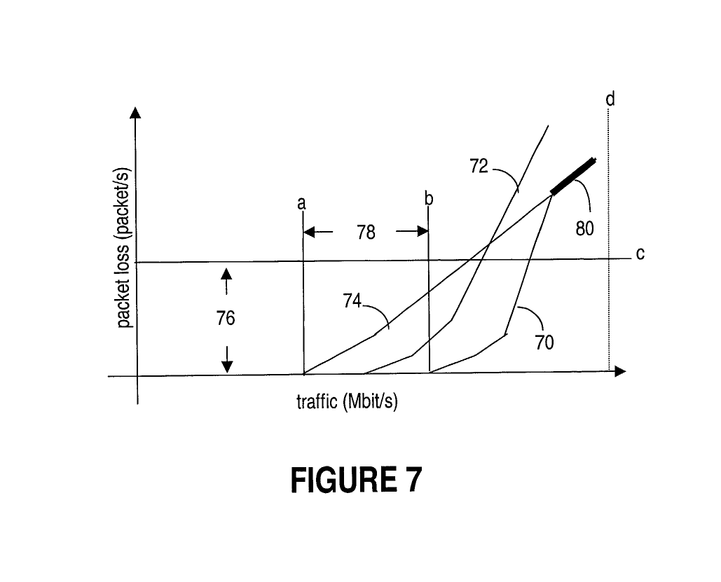

FIG. 7 is a graph comparing the traffic throughput of a network with and without the controllers 10 to provide bandwidth management. The graph has three curves showing network performance: MPLS with controllers, curve 70, MPLS without controllers, curve 72, and IP traffic using (OSPF) curve 74. Typical operational range of a network is shown by the area 76 between the horizontal line labelled ‘c’ and the horizontal axis. Vertical lines ‘a’ and ‘b’ show the traffic level at which IP traffic using OSPF and MLS traffic with the controllers start to experience packet loss, respectively. Line ‘d’ represents the theoretical maximum throughput for the network.

In any network there is unused bandwidth that is inaccessible because of redundant paths that are needed in case of link failure. These protection paths are not used, or are used for carrying lower priority traffic that is discarded in the case of a fault. Also, a path will seldom use 100% of the available bandwidth on the path. Furthermore, in most networks there is bandwidth that is reserved /committed to fulfil a QoS agreement. The controller 10 allows the network to access this unused bandwidth by dynamically setting up the MPLS paths, maintaining bandwidth allocation on the paths, and establishing new connections at layer-1 or changing connections at layer-1 to adapt to changing traffic patterns at layer-3. From FIG. 7 it is apparent the controllers' 10 ability to increase the volume of traffic that can be sent without packet loss 78 by using more of the available bandwidth. This holds true until the majority of the links on the network become highly congested. At this point, IP traffic following the OSPF protocol becomes more efficient than MPLS paths established by the controllers 10. Although it would be extremely rare for a network to operate at such a congested level, should this occur, the controllers 10 will prioritize OSPF routing as shown by the portion 80 of line 70 shown in bold.

Controller Layering

A hierarchical model for the arrangement of controllers in a large network is described next for an example network having twelve nodes. However, this hierarchical model is optional.

The interaction of controllers between domains can be thought of as an exterior gateway protocol. Within an area, the optimization required of the controller is greater than it is between areas. In a large network, areas may themselves be grouped hierarchically. The number of levels of hierarchy in any domain should be the same for all nodes. The highest level of hierarchy corresponds to the domain itself. As a minimum, a domain should contain at least one area.

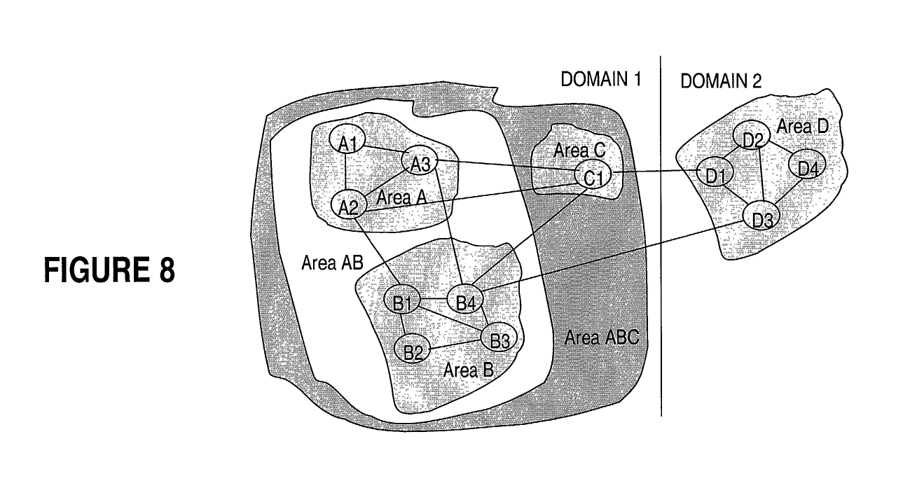

FIG. 8 is a topographical representation of a network provided with controllers, the network logically partitioned into domains, areas, and nodes. Domain 1 includes five areas: A, B, C, AB, and ABC. Area A is comprised of three nodes: A1, A2, A3. Area B is comprised of four nodes: B1, B2, B3, B4. Area C is comprised of one node: C1. Area AB is the combination of Areas A and B. Area ABC is comprised of Areas AB and C. Domain 2 is comprised of one area: Area D.

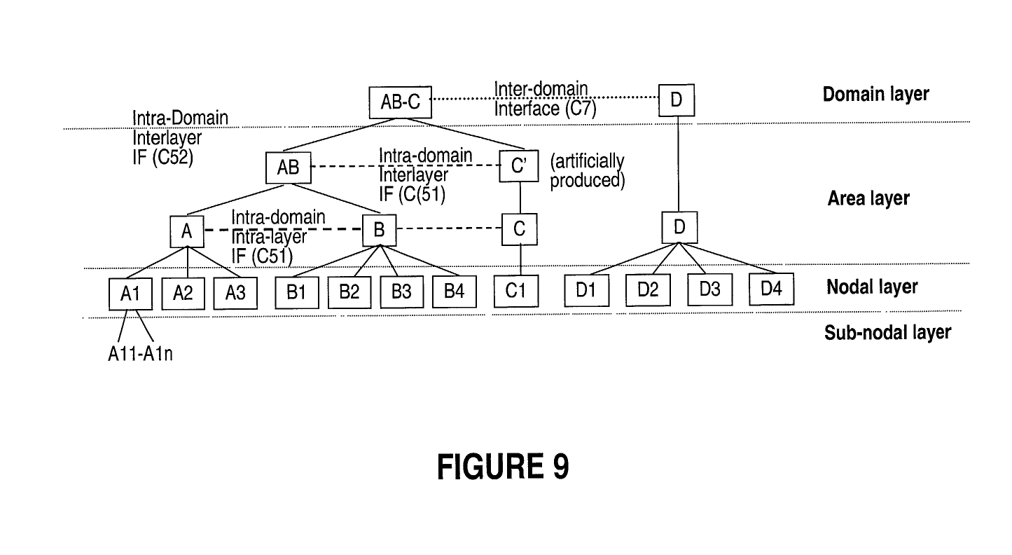

FIG. 9 is a hierarchical representation of the network of FIG. 8. The controllers are arranged hierarchically into layers by their span of control with the layers denoted as, from lowest to highest, a nodal layer, an area layer, and a domain layer. At least one nodal-controller is associated with each node. In addition, there is an area-controller associated with each area, arranged in a hierarchy as illustrated in FIG. 9. The roles of each of the controller layers are as follows:

nodal controllers: these are responsible for collecting detailed information at a top-level (typically associated with a link or LSP), for analyzing this information, and making node-level decisions based on this information. A node-level decision involves rebalancing path utilizations without modifying network topology.

area controllers: there is any number of these in the hierarchy. They are responsible for making area-wide decisions that could not be handled at the nodal level

domain controllers: there is only one of these for each domain. They are responsible for making inter-domain decisions.

A decision to adjust the fractions of traffic using two different links out of a node might be taken at the nodal level. The decision to route traffic through A1-A2-B1-B4 to offload A1-A3-B4 would require agreement at the Area AB level without reference to Area ABC. The decision to route through A1-A3-C1 would require agreement at the Area ABC level without reference to domains. Finally, the decision to route through A1-A3-C1-D3 would require agreement at the inter-domain level.

In conclusion, each controller summarizes information at its own level, makes rebalancing decisions at this level, and provides summarized information to a controller in the next higher layer of the hierarchy.

Distribution of the functionality used to implement the controllers is, to some extent, a design decision. Preferably, the controllers would be distributed as follows:

nodal-controllers: these run on the corresponding nodal equipment.

area-controllers: these run on one of the nodes in the area. In this mode one nodal-controller in each of the lower-layer groups is nominated in Private Network-Network Interface (PNNI)-fashion to act as the group's representative at the higher level.

While the invention has been described with reference to particular example embodiments, further modifications and improvements, which will occur to those skilled in the art, may be made within the purview of the appended claims, without departing from the scope of the invention in its broader aspect.

We claim:

1. A controller for managing bandwidth in a communications network, the controller comprising:
a service controller;
a service interface between the service controller and a service network element in the network for managing paths; and
a facility interface between the service controller and a transport network element in the network for managing connections,
the service controller being operable to set up paths automatically and dynamically balance the bandwidth utilization among a plurality of selected paths in response to current traffic requirements on the plurality of selected paths.

2. The controller of claim 1, wherein the service controller is further operable to establish connections automatically in response current traffic requirements on the said plurality of selected paths.

3. The controller of claim 2, wherein the service controller is further operable to set up the paths automatically in accordance with user-defined policies.

4. The controller of claim 3, wherein the service controller comprises a database for storing the user-defined policies.

5. The controller of claim 4, wherein the service controller further comprises algorithm plug-ins for selectively changing aspects of the service controller functionality.

6. The controller of claim 5, wherein the service controller further comprises:
a metrics database; and
data filters,
the service controller further operable to provide metrics monitoring in accordance with the metrics database information and data filters.

7. The controller of claim 6, further comprising a management interface for maintaining said user-defined policies.

8. The controller of claim 7, wherein said management interface is operable to obtain audit trails and explanations of every action performed, and obtain recommendations from the service controller on actions to be performed.

9. The controller of claim 2, further comprising an intra-layer interface for communication with another controller.

10. A network controller comprising a plurality of the controllers of claim 1 logically arranged in a hierarchical control structure, whereby at least one of said controllers is operable to control the operation of the other controllers.

11. The controller of claim 1 at a node in the network, the node comprising a service node and a facility node.

12. The controller of claim 11 wherein the service node comprises a core router.

13. The controller of claim 12 wherein the facility node comprises an optical transport switch.

14. The controller of any one of claims 1 to 13 wherein the paths are layer-3 paths and the connections are layer-1 connections.

15. A controller for a communications network comprising:
resource conservation means for automatically maintaining the bandwidth allocation of paths between two service nodes in the network at a level that is adjusted dynamically in accordance with a current traffic utilization level of the paths; and
resource deployment means for automatically redistributing network resources between the paths.

16. A controller as claimed in claim 15, wherein said resource conservation means is operable to allocate additional bandwidth to a path automatically whenever the current traffic utilization level on said path exceeds a high threshold.

17. A controller as claimed in claim 16, wherein said resource conservation means is operable to reduce the bandwidth allocated to a path automatically whenever the current traffic utilization level on said path is below a low threshold.

18. A controller as claimed in claim 17, wherein said resource conservation means is operable to reduce bandwidth allocated to said path automatically in decrements that are smaller than a previous increment of additional bandwidth allocated to said path.

19. A controller as claimed in claim 18, wherein said resource deployment means is operable to create a new path automatically between said two service nodes if the bandwidth allocation of said path cannot be increased.

20. A controller as claimed in claim 19, wherein said resource deployment means is operable to manage connections automatically in a facility layer based on new demands in a service layer.

21. A network controller comprising a plurality of the controllers of claim 15 logically arranged in a hierarchical control structure, whereby at least one of said controllers is operable to control the operation of the other controllers.

22. The controller of claim 15 wherein the communications network is a packet-based services network.

23. The controller of claim 22 wherein the packet-based services network is an IP network.

24. The controller of anyone of claims 15 to 19 wherein the paths are MPLS paths.
